(19) United States
(12) Patent Application Publication
(10) Pub. No.: US 2007/0182870 A1
(43) Pub. Date: Aug. 9, 2007

(54) SIGNAL PROCESSING DEVICE, LIQUID CRYSTAL DISPLAY, SYSTEM FOR TESTING LIQUID CRYSTAL DISPLAY AND METHOD OF DRIVING THE LIQUID CRYSTAL DISPLAY

(75) Inventor: Sang-chul LEE, Seongnam-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/672,111

(22) Filed: Feb. 7, 2007

(30) Foreign Application Priority Data
Feb. 8, 2006 (KR) 1020060012119

(51) Int. Cl. H04N 3/14

(52) U.S. Cl. 348/790

(57) ABSTRACT

A signal processing device, a liquid crystal display, a system for testing the liquid crystal display and a method of driving the liquid crystal display are disclosed. The signal processing device includes an external signal provider providing an external clock signal and an external driving voltage and outputting a check signal to an outside of the signal processing device, a memory unit storing reference data corresponding to the external clock signal and a checking unit comparing the external clock signal with the reference data and feeding back the check signal to the external signal provider according to the result of the comparison. The check signal represents whether the external clock signal has been inputted to the external signal provider without any error.

This application claims priority to Korean Patent Application No. 10-2006-0012119 filed on Feb. 8, 2006, and all the benefits accruing therefrom under 35 U.S.C. § 119, the contents of which are incorporated herein by reference in its entirety.

### BACKGROUND OF THE INVENTION

1. Field of the Invention

The present invention relates to a signal processing device, a liquid crystal display and a system for testing the liquid crystal display, and more particularly, to a signal processing device that can protect a liquid crystal display, a liquid crystal display, a system for testing the liquid crystal display and a method of driving the liquid crystal display.

2. Description of the Related Art

A liquid crystal display (“LCD”) includes first and second display panels in which pixel electrodes and a common electrode are formed and a liquid crystal layer interposed between the first and second display panels. The pixel electrodes are arranged in a region in which a plurality of gate lines and a plurality of data lines cross one another in the form of a matrix and are connected to switching elements such as thin film transistors, etc. A gate turn-on voltage (“Von”) and a gate turn-off voltage (“Voff”) are sequentially applied to the gate lines through a gate driver. In addition, analog driving voltage (“AVDD”) as a data driving voltage is provided to a gray scale voltage generator. A plurality of gray scale voltages provided from the gray scale voltage generator are applied to the data lines through a data driver.

The gate turn-on voltage (“Von”), the gate turn-off voltage (“Voff”) and the data driving voltage (“AVDD”) are generated by boosting or reducing a driving voltage (“VDD”) provided to the liquid crystal display. A driving voltage generator which boosts or reduces a voltage operates in a predetermined power sequence.

However, when an external clock signal is a signal that is not appropriate for driving the liquid crystal display, for example, when the length of a data enable signal (“DE”) is short, a signal control unit does not provide a signal for driving the driving voltage generator.

In some instances, an external clock signal that is not appropriate for driving the liquid crystal display may be applied to the liquid crystal display. If such an inappropriate external clock signal is applied to the liquid crystal display for a continued time, the driving voltage (“VDD”) provided to the liquid crystal display may not be converted into the gate turn-on voltage (“Von”), the gate turn-off voltage (“Voff”) and the data driving voltage (“AVDD”) but may be directly applied to the gate driver or the data driver, causing an overcurrent to flow into a drive integrated circuit (“IC”), which is disposed inside the gate driver or the data driver and resulting in damages to the drive IC. This ultimately causes defects in the liquid crystal display. The above-described problem can occur while the liquid crystal display is being tested and even after the testing, while the liquid crystal display is being used.

Accordingly, when an inappropriate external clock signal is applied to the liquid crystal display, the user should be notified of the inappropriate external clock signal being applied to the liquid crystal display and power provided from the outside should be controlled to protect the liquid crystal display.

### BRIEF SUMMARY OF THE INVENTION

An exemplary embodiment provides a signal processing device that is disposed inside a liquid crystal display and can protect the liquid crystal display while the liquid crystal display is being used.

An exemplary embodiment provides a liquid crystal display that can be protected while the liquid crystal display is being used.

An exemplary embodiment provides a system for testing the liquid crystal display that can protect the liquid crystal display while the liquid crystal display is being tested. An exemplary embodiment provides a method of driving the liquid crystal display that can protect the liquid crystal display while the liquid crystal display is being tested.

In an exemplary embodiment, there is provided a signal processing device including an external signal provider providing an external clock signal and an external driving voltage and outputting a check signal to the outside of the liquid crystal display, a memory unit storing reference data corresponding to the external clock signal and a checking unit comparing the external clock signal with the reference data and feeding back the check signal to the external signal provider according to the result of the comparison. The check signal represents whether or not the external clock signal is inputted to the external signal provider without any error.

In an exemplary embodiment, there is provided a liquid crystal display including an external signal provider providing an external image signal, an external clock signal, and a driving voltage and outputting a check signal to the outside, a memory unit storing reference data corresponding to the external clock signal, a signal-processing unit which receives the external image signal and provides an internal image signal and which receives the external clock signal and provides an internal clock signal, an image display unit displaying predetermined images corresponding to the internal image signal in response to the internal clock signal, a driving voltage generator receiving the driving voltage and generating a plurality of internal driving voltages needed in driving the image display and a checking unit comparing the external clock signal with the reference data and feeding back the check signal that represents whether the external clock signal is inputted to the external signal provider without any error, to the external signal provider according to the result of the comparison.

In an exemplary embodiment, there is provided a system for testing a liquid crystal display, the test system includes a test signal provider providing a test external image signal, a test external clock signal, and a test driving voltage and a liquid crystal display to be tested. The liquid crystal display to be tested includes a memory unit storing reference data corresponding to the test external clock signal, a signal-processing unit which receives the test external image signal and provides a test internal image signal and which receives the test external clock signal and provides a test internal clock signal, an image display unit displaying predetermined images corresponding to the test internal image signal in response to the test internal clock signal and a checking unit comparing the test external clock signal with the reference data and feeding back the check signal that represents whether the test external clock signal is inputted without any error, to the test external signal provider according to the result of the comparison. The liquid crystal display to be tested is driven by the test driving voltage.

In an exemplary embodiment, there is provided a method of driving the liquid crystal display, the method includes providing an external clock signal and an external driving voltage to an inside of the liquid crystal display and outputting a check signal from an external signal provider; and comparing the external clock signal with a reference data corresponding to the external clock signal in a checking unit feeding the check signal to the external signal provider, wherein the fed check signal represents whether the external clock signal is inputted to the external signal provider without any error according to the comparing.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an exemplary embodiment of a signal processing device according to the present invention;

FIG. 2 is a block diagram of an exemplary embodiment of a checking unit illustrated in FIG. 1;

FIG. 3 is a block diagram of an exemplary embodiment of a liquid crystal display according to the present invention;

FIG. 4 is a block diagram of an exemplary embodiment of an image display unit illustrated in FIG. 3; and

FIG. 5 is a block diagram of an exemplary embodiment of a system for testing a liquid crystal display according to the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

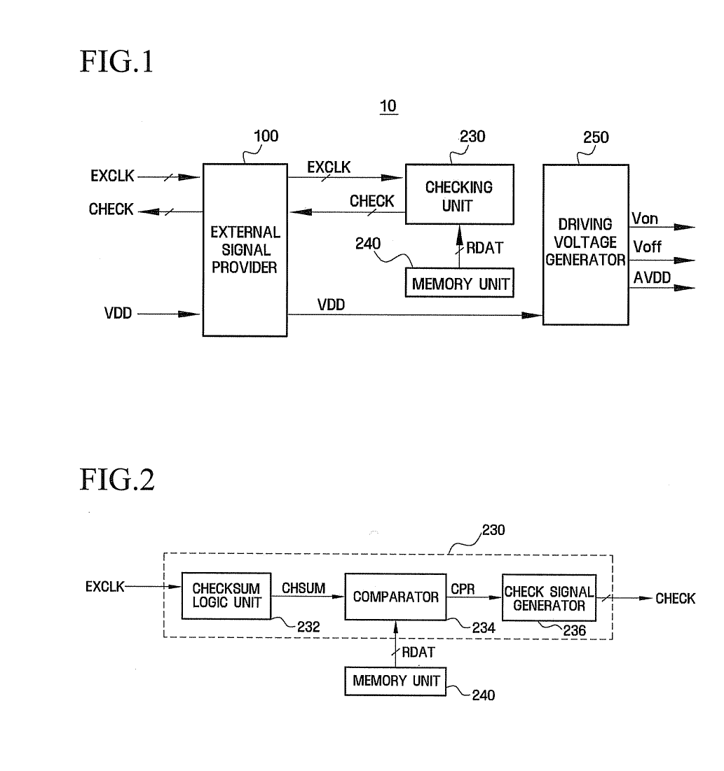

FIG. 1 is a block diagram of an exemplary embodiment of a signal processing device according to the present invention.

Referring to FIG. 1, a signal processing device 10 includes an external signal provider 100, a checking unit 230, a memory unit 240 and a driving voltage generator 250.

An external clock signal (“EXCLK”) and an external driving voltage (“VDD”) are inputted to the external signal provider 100 from outside of the signal processing device 10.

The external signal provider 100 provides the external clock signal (“EXCLK”) and the external driving voltage (“VDD”) to the inside of a liquid crystal display (not shown) and outputs a check signal (“CHECK”) to the outside. The external clock signal (“EXCLK”) is a signal for driving the liquid crystal display. In exemplary embodiments, the external clock signal (“EXCLK”) includes, but is not limited to, a vertical synchronizing signal (“Vsync”) which is a signal used to distinguish between frames, a horizontal synchronizing signal (“Hsync”), which is a signal used to distinguish between data lines, a data enable signal (“DE”), which is a high level during a period in which data is outputted and a main clock signal (“MCLK”) etc.

The external driving voltage (“VDD”) is provided to the driving voltage generator 250 through the external signal provider 100. The external driving voltage (“VDD”) is inputted to the driving voltage generator 250 and the driving voltage generator 250 generates a plurality of internal driving voltages. In exemplary embodiments, the internal driving voltages include, but are not limited to, a gate turn-on voltage (“Von”), a gate turn-off voltage (“Voff”), and a data driving voltage (“AVDD”).

The external signal provider 100 outputs the check signal (“CHECK”) fed back from the checking unit 230 to the outside. The check signal (“CHECK”) is a signal that represents whether an error occurs in the external clock signal (“EXCLK”).

In an exemplary embodiment, the abnormal operation of an liquid crystal display (not shown) may be attributable to an error occurring in the external clock signal (“EXCLK”), like in a case when no external clock signal (“EXCLK”) is inputted to the external signal provider 100 or when the length of the data enable signal (“DE”) is shortened or extended to then be inputted.

When an error occurs in the external clock signal (“EXCLK”), the liquid crystal display (not shown) cannot operate normally. The external signal provider 100 outputs to the outside the check signal (“CHECK”) in a predetermined form that represents whether an error occurs in the external clock signal (“EXCLK”), thereby notifying the outside of the liquid crystal display of whether or not the liquid crystal display operates normally.

In addition, when an error occurs in the external clock signal (“EXCLK”), the external signal provider 100 may block the external driving voltage (“VDD”) and not provide the external driving voltage (“VDD”) to the driving voltage generator 250.

If the liquid crystal display (not shown) is not operating normally, the external driving voltage (“VDD”) is not converted into the internal driving voltages such as the data driving voltage (“AVDD”), the gate turn-on voltage (“Von”) and/or the gate turn-off voltage (“Voff”) through the driving voltage generator 250, but is directly applied to a drive integrated circuit (“IC”) (not shown) inside the liquid crystal display (not shown) and an overcurrent occurs in the liquid crystal display (not shown).

If the liquid crystal display is not operating normally, the external driving voltage (“VDD”) may need to be blocked. If the checking unit 230 feeds back the check signal (“CHECK”) in the predetermined form indicating an error, the check signal (“CHECK”) is inputted to the external signal provider 100 and the external signal provider 100 can block provision of the external driving voltage (“VDD”).

In an exemplary embodiment, the checking unit 230 checks whether the external clock signal (“EXCLK”) needed for driving the liquid crystal display (not shown) is inputted to the external signal provider 100 without any error. The operation and internal circuit of the checking unit 230 will be described later with reference to FIG. 2.

The memory unit 240 provides reference data (“RDAT”) corresponding to the external clock signal (“EXCLK”) to the checking unit 230. Data needed for driving the liquid crystal display (not shown) is stored in the memory unit 240. The data may include the resolution of the liquid crystal display (not shown) and/or information about the external clock signal (“EXCLK”) needed for driving the liquid crystal display (not shown). In one exemplary embodiment, the memory unit 240 may be an electrically erasable programmable read-only memory (“EEPROM”).

In exemplary embodiments, the signal processing device 10 may be mounted on a printed circuit board (“PCB”). In one exemplary embodiment, the external signal provider 100, the checking unit 230, the memory unit 240 and/or the driving voltage generator 250 may be mounted on the PCB so that they can be used for the liquid crystal display (not shown).

FIG. 2 is a block diagram of an exemplary embodiment of the checking unit illustrated in FIG. 1.

Referring to FIG. 2, the checking unit 230 includes a checksum logic unit 232, a comparator 234 and a check signal generator 236.

The external clock signal (“EXCLK”) from the external signal provider 100 is inputted to the checksum logic unit 232 and the checksum logic unit 232 performs a checksum operation. In one exemplary embodiment, in the case of a 16-bit checksum, the checksum logic unit 232 divides the external clock signal “EXCLK”) into 16 bits and represents the divided external clock signal (“EXCLK”) with a plurality of hexadecimal numbers and sums each of the hexadecimal numbers. The checksum logic unit 232 provides a checksum signal (“CHSUM”) to the comparator 234.

The comparator 234 compares reference data (“RDAT”) corresponding to the external clock signal (“EXCLK”), which is pre-stored in the memory unit 240, with the checksum (“CHSUM”) of each of the hexadecimal numbers provided from the checksum logic unit 232. The comparator 234 provides a comparison signal (“CPR”) which is the result of comparison, to the check signal generator 236.

The check signal generator 236 feeds back the check signal (“CHECK”) that represents whether or not an error occurs in the external clock signal EXCLK, to the external signal provider 100 as illustrated in FIG. 1 according to the comparison signal (“CPR”).

In one exemplary embodiment, if a data enable signal (“DE”) is inputted to the checksum logic unit 232 through the external signal provider 100, the checksum logic unit 232 adds up per two bytes of the data enable signal (“DE”). The checksum logic unit 232 provides a checksum (“CHSUM”) which is a sum of two bytes to the comparator 234. The comparator 234 compares reference data (“RDAT”) corresponding to the data enable signal (“DE”), which is pre-stored in the memory unit 240, with the checksum (“CHSUM”). The comparator 234 provides a comparison signal (“CPR”) which is the result of comparison, to the check signal generator 236.

If the checksum (“CHSUM”) is the same as the reference data (“RDAT”), the data enable signal (“DE”) inputted to the external signal provider 100 of FIG. 1 is provided to the liquid crystal display (not shown) without any error. The check signal generator 236 feeds back a check signal (“CHECK”) in a predetermined form, representing that an error does not occur in the data enable signal (“DE”), to the external signal provider 100. If the checksum (“CHSUM”) is not the same as the reference data (“RDAT”), an error occurs in the inputted data enable signal (“DE”) and the check signal generator 236 feeds back the check signal (“CHECK”) in a predetermined form, representing that an error occurs in the inputted data enable signal (“DE”), to the external signal provider 100.

The external signal provider 100 of FIG. 1 outputs the check signal (“CHECK”) received from the check signal generator 236 to the outside, thereby indicating to the outside whether the external clock signal (“EXCLK”) is inputted to the external signal provider 100 without any error and the liquid crystal display (not shown) operates normally.

In exemplary embodiments, the external signal provider 100 can continuously provide the external driving voltage (“VDD”) to the inside of the liquid crystal display (not shown) and/or block the external driving voltage (“VDD”), in response to the check signal (“CHECK”).

In one exemplary embodiment, in a case where the check signal (“CHECK”) is 2 bits, if the check signal (“CHECK”) fed back from the checking unit 230 of FIG. 1 is “00” indicating an initial state, the external signal provider 100 begins to apply the external clock signal (“EXCLK”) and the external driving voltage (“VDD”) to the inside of the liquid crystal display (not shown).

The checking unit 230 checks through a checksum whether an error occurs in the external clock signal (“EXCLK”) provided from the external signal provider 100. If an error occurs in the data enable signal (“DE”), the liquid crystal display (not shown) does not operate normally. The checking unit 230 provides a check signal (“CHECK”) of “01” to the external signal provider 100 of FIG. 1. The external signal provider 100 of FIG. 1 blocks the external driving voltage (“VDD”) if the check signal (“CHECK”) in the form of “01” is fed back.

If it is determined using the checksum that an error does not occur in the data enable signal (“DE”), the liquid crystal display (not shown) operates normally, and the checking unit 230 provides a check signal (“CHECK”) of “10” to the external signal provider 100 of FIG. 1. If the check signal (“CHECK”) of “10” is fed back, the external signal provider 100 of FIG. 1 continuously provides the external clock signal (“EXCLK” and the external driving voltage (“VDD”) to the inside of the liquid crystal display (not shown).

As in the illustrated exemplary embodiment, if an error occurs in the external clock signal (“EXCLK”) and the liquid crystal display (not shown) does not operate normally, the external signal provider 100 blocks provision of the external driving voltage (“VDD”) and prevents the external driving voltage (“VDD”) from being continuously applied to a drive IC (not shown) inside the liquid crystal display (not shown) and an overcurrent from occurring in the liquid crystal display (not shown). Advantageously, damage to the liquid crystal display (not shown) can be reduced or effectively prevented and the liquid crystal display can thereby be protected.

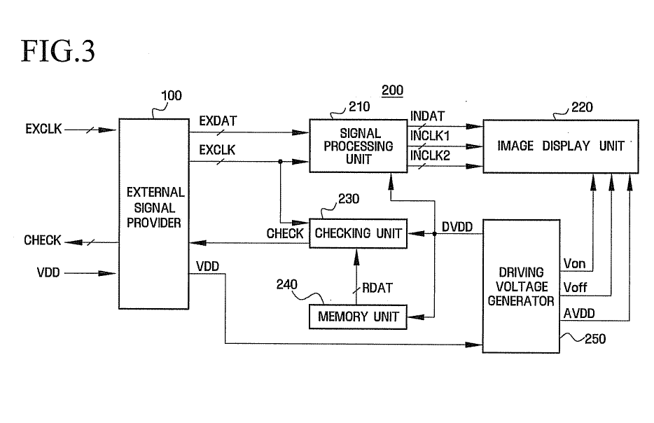

FIG. 3 is a block diagram of an exemplary embodiment of a liquid crystal display according to the present invention.

Referring to FIG. 3, a liquid crystal display 200 includes an external signal provider 100, a signal-processing unit 210, an image display unit 220, checking unit 230, a memory unit 240 and a driving voltage generator 250.

An external clock signal (“EXCLK”) and an external image signal (EXDAT) are inputted to the signal-processing unit 210. The signal-processing unit 210 provides internal clock signals (“INCLK1”, “INCLK2”) and an internal image signal (INDAT) to the image display unit 220.

The internal clock signals (“INCLK1”, “INCLK2”) may include, but are not limited to, a gate control signal (“INCLK1”) for controlling a gate driver (not shown) inside the display unit 220 and a data control signal (“INCLK2”) for controlling a data driver (not shown). The external image signal (“EXDAT”) may include, but is not limited to, red, green, and blue information and the internal image signal (“INDAT”) is a signal obtained by converting the external image signal (“EXDAT”) so that the data driver (not shown) can process the internal image signal (“INDAT”).

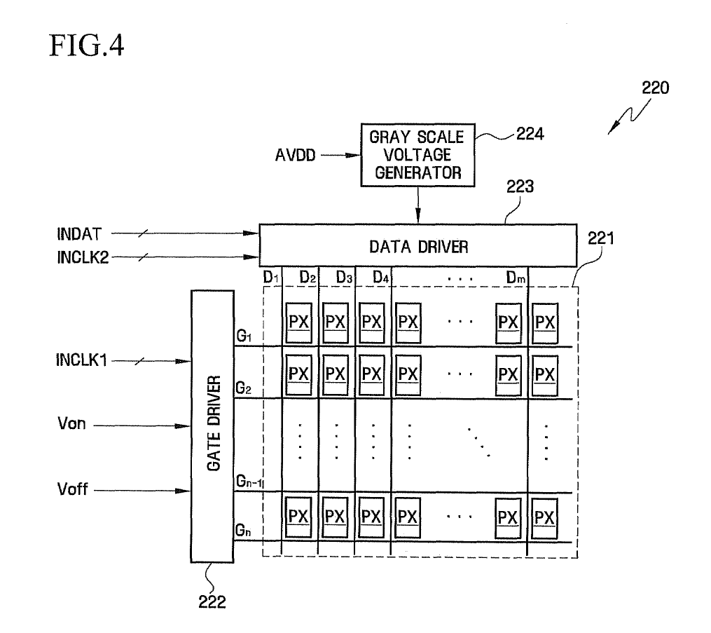

In an exemplary embodiment, the internal clock signals (“INCLK1”, “INCLK2”), the internal image signal (“INDAT”), a gate turn-on voltage (“Von”) and a gate turn-off voltage (“Voff”), and a data driving voltage (“AVDD”) are inputted to the display unit 220. The display unit 220 displays predetermined images. The image display unit 220 will be described later with reference to FIG. 4.

The driving voltage generator 250 receives the external driving voltage (“VDD”) from the external signal provider 100 and generates an internal driving voltage having a plurality of levels. The internal driving voltage may include, but is not limited to, digital driving voltages (“DVDD”), a gate turn-on voltage (“Von”), a gate turn-off voltage (“Voff”), and an analog data driving voltage (“AVDD”).

The checking unit 230 checks through a checksum whether an error occurs in the external clock signal (“EXCLK”) provided through the external signal provider 100 to the liquid crystal display 200. The checking unit 230 feeds back the check signal (“CHECK”) in a predetermined form, representing whether an error occurs in the external clock signal (“EXCLK”), to the external signal provider 100 according to the check result. The external signal provider 100 outputs the fed-back check signal (“CHECK”) to the outside. In the illustrated exemplary embodiment, whether the liquid crystal display 200 operates normally is determined depending on whether an error occurs in the external clock signal (“EXCLK”) inputted to the inside of the liquid crystal display 200.

The external signal provider 100 outputs to the outside the check signal (“CHECK”) representing whether an error occurs in the external clock signal (“EXCLK”), thereby indicating to the outside whether the liquid crystal display (not shown) operates normally. In addition, the check signal (“CHECK”) is inputted to the external signal provider 100 and the external signal provider 100 can block the external driving voltage (“VDD”) provided to the liquid crystal display 200.

As in the illustrated exemplary embodiment, when an error occurs in the external clock signal (“EXCLK”), the liquid crystal display 200 cannot operate normally. The checking unit 230 feeds back the check signal (“CHECK”) representing whether an error occurs in the external clock signal (“EXCLK”), to the external signal provider 100, and the external signal provider 100 blocks the external driving voltage (“VDD”) in response to the check signal (“CHECK”). Advantageously, an overcurrent can be prevented from occurring in the liquid crystal display 200 and the liquid crystal display 200 can be protected.

FIG. 4 is a block diagram of an exemplary embodiment of an image display unit illustrated in FIG. 3.

Referring to FIG. 4, the image display unit 220 includes a liquid crystal panel 221, a gate driver 222, a data driver 223 and a gray scale voltage generator 224.

The liquid crystal panel 221, such as is illustrated in equivalent circuit form, includes a plurality of pixels (“PX”) which are connected to a plurality of display signal lines (“G₁-Gₙ,” “D₁-Dₘ”) and are arranged in a matrix form.

The display signal lines (“G₁-Gₙ,” “D₁-Dₘ”) include a plurality of gate lines (“G₁-Gₙ”) transmitting a gate signal and a plurality of data lines (“D₁-Dₘ”) transmitting a data signal. The gate lines (“G₁-Gₙ”) extend in approximately a row direction and are parallel or substantially parallel to one another. The data lines (“D₁-Dₘ”) are formed between two adjacent pixels (“PX”), extend in approximately a column direction and are parallel or substantially parallel to one another.

The gate driver 222 includes a plurality of gate driving ICs. The gate driver 222 is connected to one side of the gate lines (“G₁-Gₘ”) and applies a gate turn-on voltage (“Von”) or a gate turn-off voltage (“Voff”) to each of the gate lines (“G₁-Gₙ”) in response to a gate control signal (“INCLK1”).

The gate turn-on voltage (“Von”) is applied to each of the gate lines (“G₁-Gₙ”) and a data voltage is applied to a corresponding pixel (“PX”) through the data lines (“D₁-Dₘ”) so that predetermined images can be displayed on the liquid crystal panel 221.

The data driver 223 includes a plurality of data driving ICs. The data driver 223 provides a data voltage to each of the data lines (“D₁-Dₘ”). The data driver 223 selects a gray scale voltage corresponding to predetermined data among a plurality of gray scale voltages provided from the gray scale voltage generator 224 and applies the selected gray scale voltage as a data voltage to the pixel (“PX”).

The gray scale voltage generator 224 generates a gray scale voltage of a positive polarity or negative polarity based on a common voltage. In exemplary embodiments, the gray scale voltage generator 224 includes a plurality of resistors connected in series between a node to which the data driving voltage (“AVDD”) is applied and ground. In one exemplary embodiment, the gray scale voltage generator 224 generates the gray scale voltage by dividing a voltage level of the data driving voltage (“AVDD”). An internal circuit of the gray scale voltage generator 224 is not limited to this and may be implemented in various shapes.

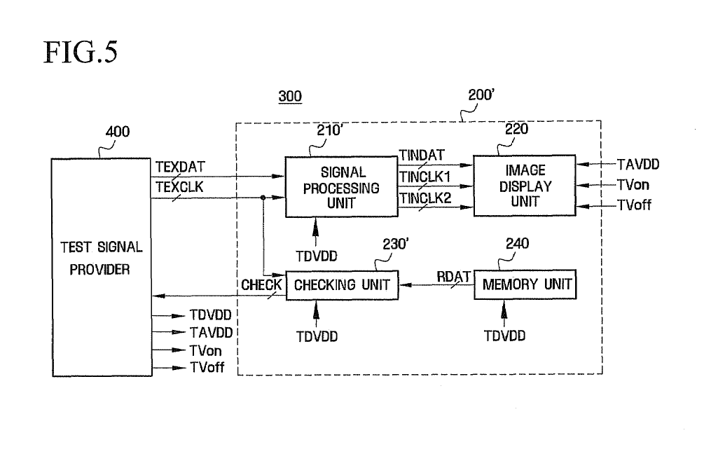

FIG. 5 is a block diagram of an exemplary embodiment of a system for testing a liquid crystal display according to the present invention.

A test system 300 of the liquid crystal display illustrated in FIG. 5 may be a test system which performs an aging operation on a liquid crystal display 200′ to be tested and/or a test system which performs a final test after the aging operation.

Referring to FIG. 5, the test system 300 of a liquid crystal display includes a test signal provider 400 and a liquid crystal display 200′ to be tested.

The test signal provider 400 provides a test external clock signal (“TEXCLK”), a test external image signal (“TEXDAT”), a test digital driving voltage (“TDVDD”), a test data driving voltage (“TAVDD”), a test gate turn-on voltage (“TVon”) and a test gate turn-off voltage (“TVoff”), which are used to test the liquid crystal display 200′ to be tested.

The test external clock signal (“TEXCLK”) is a signal for driving the liquid crystal display 200′ to be tested. In exemplary embodiments, the test external clock signals (“TEXCLK”) may include, but are not limited to, a vertical synchronization signal (“Vsync”) which is a signal used to distinguish between frames, a horizontal synchronizing signal (“Hsync”), which is a signal used to distinguish between data lines, a data enable signal (“DE”), which is a high level during a period in which data is to be outputted and a main clock signal (“MCLK”).

In exemplary embodiments, the test external image signal (“TEXDAT”) may be an image signal for testing a pattern of the liquid crystal display 200′ to be tested, a signal for testing image-sticking and/or a signal for testing a crosstalk phenomenon.

In an exemplary embodiment, the test signal provider 400 may provide high voltage test signals (“TDVDD”, “TAVDD”, “TVon”, “TVoff”) for a high voltage stress (“HVS”) test performed during an aging process. In one exemplary embodiment, the test gate turn-on voltage (“TVon”) may be about 32 volts (V) and the test data driving voltage (“TAVDD”) may be about 16 V.

The liquid crystal display 200′ to be tested includes a signal-processing unit 210′, an image display unit 220, a checking unit 230′ and a memory unit 240.

A test external clock signal (“TEXCLK”) and a test external image signal (“TEXDAT”) are inputted to the signal-processing unit 210′ from the test signal provider 400. The signal-processing unit 210′ provides test internal clock signals (“TINCLK1”, “TINCLK2”) and a test internal image signal (“TINDAT”) to the display unit 220.

The test internal clock signals (TINCLK1, TINCLK2) may include, but are not limited to, a test gate control signal (“TINCLK1”) controlling a gate driver (not shown) inside the display unit 220 and a test data control signal (“TINCLK2”) controlling a data driver (not shown). The test internal image signal (“TINDAT”) is a signal obtained by converting the external image signal (“TEXDAT”) so that it can be processed by the data driver (not shown).

The checking unit 230′ checks whether the test external clock signal (“TEXCLK”) needed in driving the liquid crystal display 200′ to be tested is inputted from the test signal provider 400 without any error. In an exemplary embodiment, the case where an error occurs in the test external clock signal (“TEXCLK”) includes the case where the liquid crystal display (not shown) cannot operate normally. In one exemplary embodiment, an error occurs in the case where the external clock signal (“TEXCLK”) for a test is not inputted to the test signal provider 400 or the case where the length of the data enable signal (“DE”) is shortened or lengthened to then be inputted. Whether an error occurs in the test external clock signal (“TEXCLK”) can be determined using a checksum.

The checking unit 230′ feeds back the check signal (“CHECK”) representing whether an error occurs in the test external clock signal (“TEXCLK”), to the test signal provider 400.

The test signal provider 400 can determine through the check signal (“CHECK”) whether the test external clock signal (“TEXCLK”) needed in driving the liquid crystal display 200′ to be tested and/or whether the liquid crystal display 200′ to be tested operates normally.

The test signal provider 400 can provide test signals (“TDVDD”, “TAVDD”, “TVon”, “TVoff”) to the liquid crystal display 200′ to be tested, or block the test signals (“TDVDD”, “TAVDD”, “TVon”, “TVoff”) according to the check signal (“CHECK”) provided from the checking unit 230′.

As in the illustrated exemplary embodiment, when an error occurs in the test external clock signal (“TEXCLK”), the checking unit 230′ feeds back the check signal (“CHECK”) in a predetermined form, and the check signal (“CHECK”) is inputted to the test signal provider 400 and the test signal provider 400 blocks provision of the test signals (“TDVDD”, “TAVDD”, “TVon”, “TVoff”). When an error does not occur in the test external clock signal (“TEXCLK”), the checking unit 230′ feeds back the check signal (“CHECK”), the check signal (“CHECK”) is inputted to the test signal provider 400 and the test signal provider 400 continuously provides the test signals (“TDVDD”, “TAVDD”, “TVon”, “TVoff”) and the test external clock signal (“TEXDAT”).

Advantageously, when the liquid crystal display 200′ to be tested cannot operate normally, provision of the test signals (“TDVDD”, “TAVDD”, “TVon”, “TVoff”, and others) is blocked and an overcurrent is prevented from occurring in the liquid crystal display 200′ to be tested and the liquid crystal display 200′ to be tested can be protected.

The memory unit 240 and the display unit 220 have the same functions as described with reference to FIG. 3, and thus, the same reference numerals are used and a description thereof will be omitted.

As in the illustrated exemplary embodiments, the signal processing device, the liquid crystal display, and the system for testing the liquid crystal display provide at least the following advantages.

In an exemplary embodiment, it is possible to notify the outside of the liquid crystal display of whether the liquid crystal display operates normally.

In an exemplary embodiment, when the liquid crystal display cannot operate normally in a normal state or a test operation, external power to be provided to the liquid crystal display is blocked such that an overcurrent is prevented from occurring in the liquid crystal display and the liquid crystal display is protected.

While the present invention has been particularly shown and described with reference to exemplary embodiments thereof, it will be understood by those skilled in the art that various changes in form and details may be made therein without departing from the spirit and scope of the invention as defined by the following claims and equivalents thereof.

What is claimed is:

1. A signal processing device comprising:
an external signal provider providing an external clock signal and an external driving voltage and outputting a check signal to an outside of the signal processing device;
a memory unit storing reference data corresponding to the external clock signal; and
a checking unit comparing the external clock signal with the reference data and feeding back the check signal to the external signal provider according to the result of the comparison, wherein the check signal represents whether or not the external clock signal is inputted to the external signal provider without an error.

2. The signal processing device of claim 1, wherein the checking unit feeds back the check signal according to a result of a checksum of the external clock signal.

3. The signal processing device of claim 2, further comprising a driving voltage generator receiving the external driving voltage and generating a gate turn-on voltage, a gate turn-off voltage and a data driving voltage.

4. The signal processing device of claim 3, wherein when the check signal is in a predetermined form representing that an error occurs when the external clock signal is inputted to the external signal provider and the check signal is fed back to the external signal provider, the external signal provider blocks provision of the external driving voltage.

5. The signal processing device of claim 4, wherein the external clock signal is one of a main clock signal, a vertical synchronizing signal, a horizontal synchronizing signal, a data enable signal and a combination including at least one of the foregoing.

6. The signal processing device of claim 5, wherein the memory unit is an electrically erasable programmable read-only memory (“EEPROM”).

7. A liquid crystal display comprising:
an external signal provider providing an external image signal, an external clock signal and an external driving voltage and outputting a check signal to the outside;
a memory unit storing reference data corresponding to the external clock signal;
a signal-processing unit receiving the external image signal and providing an internal image signal and receiving the external clock signal and providing an internal clock signal;
an image display unit displaying predetermined images corresponding to the internal image signal in response to the internal clock signal;
a driving voltage generator receiving the external driving voltage and generating a plurality of internal driving voltages driving the image display unit; and
a checking unit comparing the external clock signal with the reference data and feeding back the check signal representing whether the external clock signal is inputted to the external signal provider without any error, to the external signal provider according to the result of the comparison.

8. The liquid crystal display of claim 7, wherein the checking unit feeds back the check signal according to a result of a checksum of the external clock signal.

9. The liquid crystal display of claim 8, wherein when the check signal is in a predetermined form representing that an error occurs when the external clock signal is inputted to the external signal provider and the check signal is fed back to the external signal provider, the external signal provider blocks provision of the external driving voltage.

10. The liquid crystal display of claim 9, wherein the external clock signal is one of a main clock signal, a vertical synchronizing signal, a horizontal synchronizing signal, a data enable signal and a combination including at least one of the foregoing.

11. The signal processing device of claim 10, wherein the memory unit is an electrically erasable programmable read-only memory (“EEPROM”).

12. A system for testing a liquid crystal display comprising:
a test signal provider providing a test external image signal, a test external clock signal and a test driving voltage; and
the liquid crystal display to be tested comprising:
a memory unit storing reference data corresponding to the test external clock signal;
a signal-processing unit receiving the test external image signal and providing a test internal image signal and receiving the test external clock signal and providing a test internal clock signal;
an display unit displaying predetermined images corresponding to the test internal image signal in response to the test internal clock signal; and
a checking unit comparing the test external clock signal with the reference data and feeding back the check signal representing whether the test external clock signal is inputted to the liquid crystal display without any error, to the test signal provider according to the result of the comparison,
wherein the liquid crystal display to be tested is driven by the test driving voltage.

13. The system for testing a liquid crystal display of claim 12, wherein the checking unit feeds back the check signal according to a result of a checksum of the test external clock signal.

14. The system for testing a liquid crystal display of claim 13, wherein when the check signal is in a predetermined form representing that an error occurs when the test external clock signal is inputted to the liquid crystal display to be tested and the check signal is fed back to the test signal provider, the test signal provider blocks provision of the test driving voltage.

15. The system for testing a liquid crystal display of claim 14, wherein the test external clock signal is one of a main clock signal, a vertical synchronizing signal, a horizontal synchronizing signal, a data enable signal and a combination including at least one of the foregoing.

16. The system for testing a liquid crystal display of claim 15, wherein the memory unit is an electrically erasable programmable read-only memory (“EEPROM”).

17. A method of driving a liquid crystal display, the method comprising:
providing an external clock signal and an external driving voltage to an inside of the liquid crystal display and outputting a check signal from an external signal provider; and
comparing the external clock signal with a reference data corresponding to the external clock signal in a checking unit feeding the check signal to the external signal provider, wherein the fed check signal represents whether the external clock signal is inputted to the external signal provider without any error according to the comparing.

18. The method of claim 17, wherein the comparing the external clock signal with the reference data comprises:
performing a checksum operation in a logic unit providing a checksum signal to a comparator;
comparing the reference data with the checksum signal in the comparator providing a comparison signal to a check signal generator; and
generating the check signal in the check signal generator based on the comparison signal, the check signal generator feeding the check signal to the external signal provider.

19. The method of claim 18, wherein if the check signal fed to the external signal provider indicates the external clock signal is inputted to the external signal provider with an error, the outputting a check signal comprises blocking the provision of the external driving voltage.

20. The method of claim 18, wherein if the check signal fed to the external signal provider indicates the external clock signal is inputted to the external signal provider without an error, the outputting a check signal comprises continuously providing the external driving voltage.
